(19) United States
(12) Patent Application Publication
(10) Pub. No.: US 2022/0312424 A1
(43) Pub. Date: Sep. 29, 2022

(54) TERMINAL AND BASE STATION

(71) Applicant: NTT DOCOMO, INC., Tokyo (JP)

(72) Inventors: Neng Ye, Beijing (CN); Xiangming Li, Beijing (CN); Jianxiong Pan, Beijing (CN); Wenjia Liu, Beijing (CN); Xiaolin Hou, Beijing (CN)

(73) Assignee: NTT DOCOMO, INC., Tokyo (JP)

(21) Appl. No.: 17/597,258

(22) PCT Filed: Jul. 2, 2019
(86) PCT No.: PCT/CN2019/094432

§ 371 Date: Dec. 30, 2021

(51) Int. Cl. H04W 72/08; G06N 3/08; H04L 1/16; H04L 45/02

(52) U.S. Cl. CPC H04W 72/082; G06N 3/08; H04L 1/1614; H04L 45/08

(57) ABSTRACT

The present application provides a terminal and a base station. The terminal includes: a processing unit configured to use a neural network to map a bit sequence to be transmitted into a complex symbol sequence, wherein the neural network is configured to map the bit sequence into the complex symbol sequence within a predetermined range of a complex plane.

### TECHNICAL FIELD

The present disclosure relates to a field of wireless communication, and in particular, to a terminal and a base station in the field of wireless communication.

### BACKGROUND

At present, it has been proposed to apply a non-orthogonal multiple access (NOMA) technology to future wireless communication systems such as 5G to improve spectrum efficiency of the communication systems. Compared with a traditional orthogonal multiple access technology, NOMA uses non-orthogonal transmissions at the transmitting end and allocates a wireless resource to multiple users, which is more suitable for wireless communication services such as Internet of Things (IoT) with large communication connectivity, Massive Machine-Type Communication (mMTC) and so on. In communication transmissions using the NOMA technology, different users perform non-orthogonal transmissions on a same sub-channel, so that interference information is introduced on the transmitting side. Therefore, in order to correctly demodulate the received information, Successive Interference Cancellation (SIC) technology needs to be used on the receiving side to cancel interference information, thereby increasing the complexity of a receiver. In addition, different types of receivers need to be designed for different NOMA schemes, which has certain restrictions on the flexibility of a receiver.

On the other hand, with the development of science and technology, Artificial Intelligence (AI) technology is used in many different fields, and it has been proposed to apply the AI technology to wireless communication systems to meet the needs of users. In the AI technology, a technology called multi-task deep learning can perform multiple tasks that are related to each other at the same time. The multi-task deep learning technology has a certain duality with the non-orthogonal multiple access technology that non-orthogonally transmits multiple signals at the same time, so it can be conceived that the multi-task deep learning technology is applied to a base station or a terminal that adopts the non-orthogonal multiple access technology to realize the optimization of the non-orthogonal multiple access technology.

### SUMMARY

According to one aspect of the present disclosure, a terminal is provided, comprising: a processing unit configured to use a neural network to map a bit sequence to be transmitted into a complex symbol sequence, wherein the neural network is configured to map the bit sequence into the complex symbol sequence within a predetermined range of a complex plane.

According to one example of the present disclosure, in the above terminal, a receiving unit is further comprised, the receiving unit receives network configuration information transmitted by the base station that includes at least one of information for indicating a network configuration of the neural network used by the base station and information for indicating the network configuration of the neural network of the terminal.

According to one example of the present disclosure, in the above terminal, the processing unit configures the neural network of the terminal based on the network configuration information.

According to one example of the present disclosure, in the above terminal, the network configuration information includes network structure and network parameter information.

According to another aspect of the present disclosure, a base station is provided, comprising: a receiving unit configured to receive multiplex signal superimposed from multiple signals transmitted by multiple terminals; and a processing unit configured to restore the multiplex signal, determine preliminary estimated values of the multiplex signal through multiple tasks in a multi-task neural network, and in a first task of the multi-task neural network, delete interference caused by other signals of the multiple signals from a preliminary estimated value of a first signal determined by the first task, to determine an estimated value after interference cancellation of the first signal, wherein the interference caused by the other signals of the multiple signals is obtained based on the preliminary estimated values determined by tasks of the multiple tasks other than the first task.

According to one example of the present disclosure, in the above base station, the multi-task neural network includes a common part and multiple specific parts, each task in the multi-task neural network shares the common part which is used to determine common features of each signal of the multiple signals, and each task in the multi-task neural network corresponds to one of the specific parts which are used to determine specific features of each signal respectively.

According to one example of the present disclosure, in the above base station, the multi-task neural network includes multiple layers, the multi-task neural network includes multiple interference cancellation stages, and each interference cancellation stage includes one or more layers of the neural network, in a first interference cancellation stage, the preliminary estimated values of the multiplex signal in the first interference cancellation stage are respectively determined through the multiple tasks, and the interference obtained based on the preliminary estimated values of the other signals in the first interference cancellation stage is deleted from the preliminary estimated value of the first signal in the first interference cancellation stage determined by the first task, to determine the estimated value after interference cancellation of the first signal in the first interference cancellation stage, in a second interference cancellation stage, the preliminary estimated values of the multiplex signal in a second interference cancellation stage are respectively determined through the multiple tasks based on estimated values after interference cancellation of the multiplex signal in the first interference cancellation stage, and the interference obtained based on the preliminary estimated values of the other signals in the second interference cancellation stage is deleted from the preliminary estimated value of the first signal in the second interference cancellation stage.

According to one example of the present disclosure, a transmitting unit is further comprised in the above base station, the transmitting unit is configured to transmit information related to a structure and parameters of the multi-task neural network.

According to one example of the present disclosure, in the above base station, the multi-task neural network is configured to balance a loss of each of the multiple tasks, the loss is a difference between a value of a signal restored by each task and a true value of the signal.

According to another aspect of the present disclosure, a terminal is provided. The terminal comprises: a receiving unit configured to receive multiplex signal superimposed from multiple signals and transmitted by a base station; and a processing unit configured to restore the multiplex signal, determine preliminary estimated values of the multiplex signal through multiple tasks in a multi-task neural network, and in a first task of the multi-task neural network, delete interference caused by other signals of the multiple signals from a preliminary estimated value of a first signal determined by the first task, to determine an estimated value after interference cancellation of the first signal, wherein the interference caused by the other signals of the multiple signals is obtained based on the preliminary estimated values determined by tasks of the multiple tasks other than the first task.

According to one example of the present disclosure, in the above terminal, the multi-task neural network includes a common part and multiple specific parts, each task in the multi-task neural network shares the common part which is used to determine common features of each signal of the multiple signals, and each task in the multi-task neural network corresponds to one of the specific parts which are used to determine specific features of each signal respectively.

According to one example of the present disclosure, in the above terminal, the multi-task neural network includes multiple layers, the multi-task neural network includes multiple interference cancellation stages, and each interference cancellation stage includes one or more layers of the neural network, in a first interference cancellation stage, the preliminary estimated values of the multiplex signal in the first interference cancellation stage are respectively determined through the multiple tasks, and the interference obtained based on the preliminary estimated values of the other signals in the first interference cancellation stage is deleted from the preliminary estimated value of the first signal in the first interference cancellation stage determined by the first task, to determine the estimated value after interference cancellation of the first signal in the first interference cancellation stage, in a second interference cancellation stage, the preliminary estimated values of the multiplex signal in a second interference cancellation stage are respectively determined through the multiple tasks based on estimated values after interference cancellation of the multiplex signal in the first interference cancellation stage, and the interference obtained based on the preliminary estimated values of the other signals in the second interference cancellation stage is deleted from the preliminary estimated value of the first signal in the second interference cancellation stage.

According to one example of the present disclosure, in the above terminal, the receiving unit receives network configuration information transmitted by the base station that includes at least one of information for indicating a network configuration of the neural network used by the base station and information for indicating the network configuration of the neural network of the terminal.

According to one example of the present disclosure, in the above terminal, the processing unit configures the multi-task neural network based on the network configuration information.

According to one example of the present disclosure, in the above terminal, the network configuration information includes network structure and network parameter information.

According to one example of the present disclosure, in the above terminal, the multi-task neural network is configured to balance a loss of each of the multiple tasks, the loss is a difference between a value of a signal restored by each task and a true value of the signal.

According to another aspect of the present disclosure, a base station is provided. The base station comprises: a processing unit configured to use a neural network to map a bit sequence to be transmitted into a complex symbol sequence, wherein the neural network is configured to map the bit sequence into the complex symbol sequence within a predetermined range of a complex plane.

According to one example of the present disclosure, in the above base station, further comprising: a transmitting unit configured to transmit the bit sequence that has been mapped by the processing unit, and transmit information related to a structure and parameters of the neural network.

According to another aspect of the present disclosure, a transmitting method for a terminal is provided. The transmitting method comprises: using a neural network to map a bit sequence to be transmitted into a complex symbol sequence, wherein the neural network is configured to map the bit sequence into the complex symbol sequence within a predetermined range of a complex plane.

According to one example of the present disclosure, in the above transmitting method, network configuration information transmitted by the base station that includes at least one of information for indicating a network configuration of the neural network used by the base station and information for indicating the network configuration of the neural network of the terminal is received.

According to one example of the present disclosure, in the above transmitting method, the neural network of the terminal is configured based on the network configuration information.

According to one example of the present disclosure, in the above transmitting method, the network configuration information includes network structure and network parameter information.

According to another aspect of the present disclosure, a receiving method for a base station is provided. The receiving method comprises: receiving multiplex signal superimposed from multiple signals transmitted by multiple terminals; and restoring the multiplex signal, determining preliminary estimated values of the multiplex signal through multiple tasks in a multi-task neural network, and in a first task of the multi-task neural network, deleting interference caused by other signals of the multiple signals from a preliminary estimated value of a first signal determined by the first task, to determine an estimated value after interference cancellation of the first signal, wherein the interference caused by the other signals of the multiple signals is obtained based on the preliminary estimated values determined by tasks of the multiple tasks other than the first task.

According to one example of the present disclosure, in the above receiving method, the multi-task neural network includes a common part and multiple specific parts, each task in the multi-task neural network shares the common part which is used to determine common features of each signal of the multiple signals, and each task in the multi-task neural network corresponds to one of the specific parts which are used to determine specific features of each signal respectively.

According to one example of the present disclosure, in the above receiving method, the multi-task neural network includes multiple layers, the multi-task neural network includes multiple interference cancellation stages, and each interference cancellation stage includes one or more layers of the neural network, in a first interference cancellation stage, the preliminary estimated values of the multiplex signal in the first interference cancellation stage are respectively determined through the multiple tasks, and the interference obtained based on the preliminary estimated values of the other signals in the first interference cancellation stage is deleted from the preliminary estimated value of the first signal in the first interference cancellation stage determined by the first task, to determine the estimated value after interference cancellation of the first signal in the first interference cancellation stage, in a second interference cancellation stage, the preliminary estimated values of the multiplex signal in a second interference cancellation stage are respectively determined through the multiple tasks based on estimated values after interference cancellation of the multiplex signal in the first interference cancellation stage, and the interference obtained based on the preliminary estimated values of the other signals in the second interference cancellation stage is deleted from the preliminary estimated value of the first signal in the second interference cancellation stage.

According to one example of the present disclosure, in the above receiving method, further comprising: transmitting information related to a structure and parameters of the multi-task neural network.

According to one example of the present disclosure, in the above receiving method, the multi-task neural network is configured to balance a loss of each of the multiple tasks, the loss is a difference between a value of a signal restored by each task and a true value of the signal.

According to another aspect of the present disclosure, a receiving method for a terminal is provided. The receiving method comprises: receiving multiplex signal superimposed from multiple signals and transmitted by a base station; determining, by multiple tasks in a multi-task neural network, preliminary estimated values of the multiplex signal respectively; and deleting, in a first task of the multi-task neural network, interference caused by other signals of the multiple signals from a preliminary estimated value of a first signal determined by the first task, to determine an estimated value after interference cancellation of the first signal, wherein the interference caused by the other signals of the multiple signals is obtained based on the preliminary estimated values determined by tasks of the multiple tasks other than the first task.

According to one example of the present disclosure, in the above receiving method, the multi-task neural network includes a common part and multiple specific parts, each task in the multi-task neural network shares the common part which is used to determine common features of each signal of the multiple signals, and each task in the multi-task neural network corresponds to one of the specific parts which are used to determine specific features of each signal respectively.

According to one example of the present disclosure, in the above receiving method, the multi-task neural network includes multiple layers, the multi-task neural network includes multiple interference cancellation stages, and each interference cancellation stage includes one or more layers of the neural network, in a first interference cancellation stage, the preliminary estimated values of the multiplex signal in the first interference cancellation stage are respectively determined through the multiple tasks, and the interference obtained based on the preliminary estimated values of the other signals in the first interference cancellation stage is deleted from the preliminary estimated value of the first signal in the first interference cancellation stage determined by the first task, to determine the estimated value after interference cancellation of the first signal in the first interference cancellation stage, in a second interference cancellation stage, the preliminary estimated values of the multiplex signal in a second interference cancellation stage are respectively determined through the multiple tasks based on estimated values after interference cancellation of the multiplex signal in the first interference cancellation stage, and the interference obtained based on the preliminary estimated values of the other signals in the second interference cancellation stage is deleted from the preliminary estimated value of the first signal in the second interference cancellation stage.

According to one example of the present disclosure, in the above receiving method, network configuration information transmitted by the base station that includes at least one of information for indicating a network configuration of the neural network used by the base station and information for indicating the network configuration of the neural network of the terminal is received.

According to one example of the present disclosure, in the above receiving method, the multi-task neural network is configured based on the network configuration information.

According to one example of the present disclosure, in the above receiving method, the network configuration information includes network structure and network parameter information.

According to one example of the present disclosure, in the above receiving method, the multi-task neural network is configured to balance a loss of each of the multiple tasks, the loss is a difference between a value of a signal restored by each task and a true value of the signal.

According to another aspect of the present disclosure, a transmitting method for a base station is provided. The transmitting method comprises: using a neural network to map a bit sequence to be transmitted into a complex symbol sequence, wherein the neural network is configured to map the bit sequence into the complex symbol sequence within a predetermined range of a complex plane.

According to one example of the present disclosure, in the above transmitting method, further comprising: superimposing and transmitting the bit sequence that has been mapped by the processing unit, and transmitting information related to a structure and parameters of the neural network.

### BRIEF DESCRIPTION OF THE DRAWINGS

The foregoing and other objectives, features and advantages of the present disclosure will become clearer from more detailed description of embodiments of the present disclosure in conjunction with accompanying drawings. The accompanying drawings are used to provide a further understanding of the embodiments of the present disclosure, constitute a part of this specification, and help to explain the present disclosure together with the embodiments of the present disclosure, but are not intended to act as a limitation of the present disclosure. In the accompanying drawings, like reference numerals usually indicate like components or steps.

FIG. 1 is a schematic diagram of a wireless communication system in which the embodiments of the present disclosure may be applied.

FIG. 2 is a structural schematic diagram of a terminal according to an embodiment of the present disclosure.

FIG. 3 is a structural schematic diagram of a base station according to an embodiment of the present disclosure.

FIG. 4 is a structural schematic diagram of a base station according to another embodiment of the present disclosure.

FIG. 5 is a structural schematic diagram of a terminal according to another embodiment of the present disclosure.

FIG. 6 is a flowchart of a transmitting method according to an embodiment of the present disclosure.

FIG. 7 is a flowchart of a receiving method according to an embodiment of the present disclosure.

FIG. 8 is a schematic diagram of a hardware structure of a device involved in an embodiment of the present disclosure.

### DETAILED DESCRIPTION

In order to make objectives, technical solutions and advantages of the present disclosure clearer, exemplary embodiments according to the present disclosure will be described in detail below with reference to the accompanying drawings. Like reference numerals refer to like elements throughout the accompanying drawings. It should be understood that the embodiments described herein are merely illustrative and should not be constructed as limiting the scope of the present disclosure. Terminals described herein may include various types of terminals, such as user equipments (UEs), mobile terminals (or referred to as mobile stations) or fixed terminals. However, for the sake of convenience, terminals and UEs sometimes may be used interchangeably hereinafter. In addition, in the embodiments of the present disclosure, a neural network is an artificial neural network used in an AI function module. For brevity, it may sometimes be referred to as a neural network in the following description.

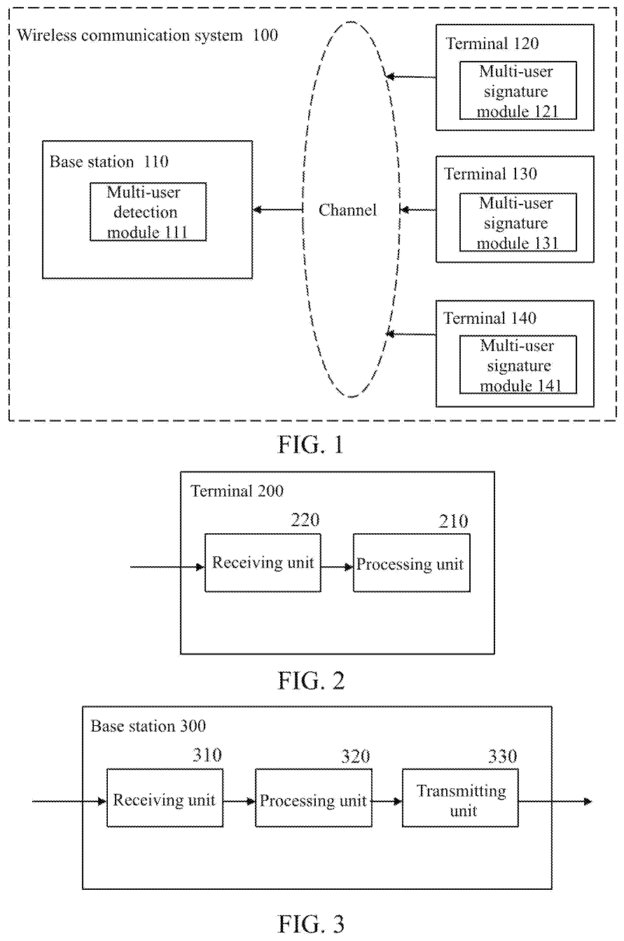

First, a wireless communication system in which the embodiments of the present disclosure may be applied will be described with referenced to FIG. 1. The wireless communication may be a 5G system, or may be any other type of wireless communication system such as an Long Term Evolution (LTE) system, an LTE-advanced (LTE-A) system, or a future communication system, etc. In the following, a 5G system is taken as an example to describe the embodiments of the present disclosure, but it should be appreciated that the following description may also be applied to other types of wireless communication systems. In the following, uplink transmissions from terminals to a base station are taken as an example for illustration.

As shown in FIG. 1, a wireless communication system 100 applying a non-orthogonal multiple access technology such as NOMA or MIMO (Multiple-Input Multiple-Output), etc. includes a base station 110, a terminal 120, a terminal 130, and a terminal 140. The base station 110 includes a multi-user detection module 111. The terminal 120, the terminal 130, and the terminal 140 include multi-user signature modules 121, 131, and 141. Assuming that multiple user terminals including the terminals 120˜140 transmit multiple signals to the base station 110, the bit sequence of each signal is sent to the multi-user signature modules 121, 131, and 141 in various terminals, respectively. The bit sequences input to the multi-user signature modules 121, 131, and 141 may be original bit sequences to be transmitted, or bit sequences after operations such as encoding, spreading, interleaving, and scrambling. In other words, operations such as encoding, interleaving, spreading, and scrambling can also be performed in the multi-user signature modules 121, 131, and 141. The input bit sequences are mapped in the multi-user signature modules 121, 131, and 141, and complex symbol sequences are output. The mapped complex symbol sequences are non-orthogonally mapped to physical resource blocks and transmitted to the base station 110.

In the base station 110, superimposed multiple signals (multiplex signal) are received and transmitted to the multi-user detection module 111. In order to correctly demodulate the signals from various terminals from the received multiplex signal, in the multi-user detection module 111, it is necessary to cancel interference caused by non-orthogonal transmissions, and restore effective signals for various users from the multiplex signal. It can be seen that in non-orthogonal multiple access technology, due to the need to cancel the interference at a receiving end, the complexity of a receiver is increased, and the hardware of the receiver needs to be configured separately for different transmission schemes, which also limits its flexibility.

In the prior art, it has been proposed to combine a neural network technology with the non-orthogonal multiple access technology. However, due to a non-orthogonal and complex relationship between signals from multiple users, it is difficult to perform training and optimization for a neural network. For example, a method of using a fully connected deep neural network (FC-DNN) to map a bit sequence to a complex symbol sequence at the transmitting end is proposed. Since the position of the complex symbol sequence obtained by this method on a complex plane is irregular, the training process involves a large number of parameters, and is difficult to be optimized. In addition, a technical solution to reduce complexity and increase flexibility of a receiving end based on a neural network has not been proposed.

In order to solve the above-mentioned problems, the present disclosure proposes a terminal and a base station. Hereinafter, a terminal according to an embodiment of the present disclosure will be explained with reference to FIG. 2. FIG. 2 is a schematic diagram of a terminal according to an embodiment of the present disclosure.

As shown in FIG. 2, a terminal 200 includes a processing unit 210. In the processing unit 210, based on the non-orthogonal multiple access technology, a multi-user signature (multiple access signature) process and a resource mapping process are performed on a bit sequence composed of bit data to be transmitted to the base station. According to the present embodiment, in the processing unit 210, a neural network is used to implement the multi-user signature process, that is, a bit sequence to be transmitted is mapped through the neural network, and a complex symbol sequence is output.

According to an example of the present invention, a bit sequence input to the neural network in the processing unit 210 may be a bit sequence that has undergone at least one of encoding, spreading, interleaving, and scrambling, or it may be an unprocessed original bit sequence. In other words, in addition to mapping a bit sequence into a complex symbol sequence, the processes performed in the neural network may include one or more of encoding, spreading, interleaving, scrambling, etc.

For example, the neural network of the terminal can map the bit sequence input to the neural network into a complex symbol sequence. And according to an embodiment of the present disclosure, by configuring the structure and parameters of the neural network, the processing unit 210 maps the bit sequence into a complex symbol sequence within a predetermined range of a complex plane. The predetermined range can be expressed as a prescribed shape on the complex plane. Alternatively, the prescribed shape may be any shape, as long as it is a subset of the complex plane. In addition, it can also be combined with knowledge in the field of communication to set the shape to be a shape which is most favorable to transmit communication. Since the mapping range of a bit sequence on the complex plane is limited, comparing with mapping methods such as those using FC-DNN, the number of parameters of a neural network is reduced, and the complexity of optimization training of a neural network is reduced.

According to an example of the present invention, in the processing unit 210, by configuring the parameters of the neural network, a complex symbol sequence obtained by the mapping is defined in a parallelogram on the complex plane. A specific implementation method is as follows.

Assuming that in uplink transmissions of non-orthogonal multiple access, the terminal 200 is the n-th terminal that transmits a bit sequence to the base station. In the processing unit 210, the bit sequence to be transmitted is mapped to a complex symbol sequence, and a parameter set of the neural network that performed the mapping is configured as Wₙ. Since the complex symbol sequence is to be limited to a parallelogram on the complex plane, the parameter set Wₙ needs to include the length of a long edge, the length of a short edge, and the degrees of two angles of the parallelogram. For example, the parameter set Wₙ can be expressed as follows:

Wₙ={Lₙ,Sₙ,θ_{L,n},θ_{S,n}} Formula (1)

wherein Lₙ represents the length of the long edge of the parallelogram, Sₙ represents the length of the short edge, and θ_{L, n} and θ_{S, n} respectively represent the two angles of the parallelogram.

In addition, assuming that a function R is used to represent the mapping rule of the neural network, R can be regarded as the structure of the neural network, and the form of R is agreed so that a complex symbol sequence obtained by the neural network mapping is limited to a parallelogram on the complex plane. For example, assuming that the maximum number of physical Resource Elements (REs) that can be mapped in non-orthogonal multiple access is 4, and the n-th signal transmitted by the terminal 200 use 2 physical Resource Elements. When the parameter set Wₙ represented by the above formula (1) is used, R can be represented as follows:

$$( {W}_{n} ) = [ \begin{matrix}{L}_{n} cos ( {θ}_{L , n} ) + {jS}_{n} cos ( {θ}_{S , n} ) & {L}_{n} sin ( {θ}_{L , n} ) + {jS}_{n} sin ( {θ}_{S , n} ) \\ - {L}_{n} cos ( {θ}_{L , n} ) + {jS}_{n} cos ( {θ}_{S , n} ) & - {L}_{n} sin ( {θ}_{L , n} ) + {jS}_{n} sin ( {θ}_{S , n} ) \\ {L}_{n} cos ( {θ}_{L , n} ) - {jS}_{n} cos ( {θ}_{S , n} ) & {L}_{n} sin ( {θ}_{L , n} ) - {jS}_{n} sin ( {θ}_{S , n} ) \\ - {L}_{n} cos ( {θ}_{L , n} ) - {jS}_{n} cos ( {θ}_{S , n} ) & - {L}_{n} sin ( {θ}_{L , n} ) - {jS}_{n} sin ( {θ}_{S , n} )\end{matrix} ]$$

Through R in formula (2), the parameter set Wₙ can be mapped into a codebook of the complex symbol sequence. On this basis, for the bit sequence to be transmitted which is input to the neural network, according to its input form (for example, it can be a form that satisfies one-hot code, etc.), a corresponding codeword can be selected from the codebook generated above, therefore the mapping of the complex symbol sequence corresponding to the bit sequence is determined. For example, when Wₙ and R(Wₙ) of formula (1) and formula (2) are used, a codebook about the n-th signal obtained by the mapping can be expressed as a sequence: [X^{†}_{n,1}, X^{†}_{n,2}, X^{†}_{n,3}, X^{†}_{n,4}]^{T}. When the bit sequence to be transmitted satisfies the form of the one-hot code, and the n-th signal satisfies [0, 0, 1, 0], X^{†}_{n,3} is selected as the codeword from the above sequence to determine the mapping of the complex symbol sequence corresponding to the n-th signal.

Since the network structure R is agreed to correspond to a parallelogram mapping rule, the position of the determined complex symbol sequence on the complex plane must be within the parallelogram that satisfies the parameters of the parameter set Wₙ.

According to the above example, when the shape of the complex symbol sequence on the complex plane is limited to a shape other than parallelogram, the parameter set Wₙ is the parameters used to characterize the shape, and R is the mapping rule corresponding to the shape.

Through the above processing of the processing unit 210, the complex symbol sequence obtained by the mapping is limited to a subset of the entire complex plane, so that the complexity of the system is reduced when a neural network is applied to the multi-user signature process. In addition, since the parameter set of the neural network is set as parameters for characterizing a certain predetermined shape, the number of parameters of the neural network is reduced. For example, in the training of the neural network, it is only necessary to perform the optimization training mainly for the parameter set Wₙ, which reduces the complexity of the training.

In the processing unit 210, the complex symbol sequence obtained through the above process is mapped to a physical resource block. According to an example of the present invention, a neural network technology can be used for resource mapping. The complex symbol sequence is input into a neural network for resource mapping, and the physical resource mapping is realized through the processing of the neural network. At this time, due to the use of a neural network, the mapping of resources can be adjusted and learned. In NOMA or MIMO, the terminal 200 transmits, in a non-orthogonal multiple access mode, the bit sequence that has been mapped by the processing unit 210 and has undergone resource mapping. In the resource mapping, data of multiple terminals is allocated to the same physical resource block, and the signal received by the base station are superimposed multiple signals (multiplex signal) from the multiple terminals.

According to an example of the present invention, the structure and parameters of the neural network adopted by the processing unit 210 (for example, the aforementioned Wₙ and R) can be specified by the base station according to the non-orthogonal multiple access scheme to be adopted. In this case, the terminal 200 further includes a receiving unit 220, which receives network configuration information transmitted by the base station. The network configuration information is used to specify the network configuration of a neural network. For example, the network configuration information can directly specify the network structure and network parameters adopted by the terminal. The terminal 200 configures the neural network based on the received network configuration information. When used online, the terminal can also perform online training and optimization of the neural network based on the received network configuration information. In an example, the network configuration information may also be pre-defined precoding information, transmission scheme information, etc., for example, it may be a NOMA codebook or a MIMO codebook used in non-orthogonal communication. The network configuration information may be exchanged between the base station and the terminal 200 through high-level signaling or physical layer signaling.

According to another example of the present invention, the terminal 200 may also determine the communication scheme to be adopted by the base station through a blind detection method, thereby determining the network parameters and network structure of the neural network used for user signature. In this case, the process of signaling interaction with the base station can be omitted.

The above in conjunction with FIG. 2 illustrates the application of a neural network to a terminal that transmits in the non-orthogonal multiple access mode. Based on the same idea, a neural network can also be applied to a receiving end in the non-orthogonal multiple access technology. Hereinafter, a base station according to an embodiment of the present disclosure will be explained with reference to FIG. 3. FIG. 3 is a schematic diagram of a base station according to an embodiment of the present disclosure.

As shown in FIG. 3, a base station 300 includes a receiving unit 310 and a processing unit 320. The receiving unit 310 receives multiplex signal formed by superimposition of multiple signals from multiple terminals. The processing unit 320 needs to process the received multiplex signal to restore signals of various terminals. That is, the processing unit 320 performs a multi-user detection process on the received multiplex signal.

According to this embodiment, a multi-task neural network is used to perform the multi-user detection process. In the processing unit 320, multiple tasks in the multi-task neural network are used to restore signals from the multiplex signal received by the receiving unit 310.

According to an example of the present invention, the multi-task neural network applied to the multi-user detection process includes a common part and multiple specific parts. Each task in the multi-task neural network shares the common part, and each task in the multi-task neural network corresponds to a specific part. In the processing unit 320, the received multiplex signal is first input into the common part of the multi-task neural network for preprocessing, to determine common features of each signal (that is, features in common), and to extract effective implicit features of the input signals. The multiplex signal processed by the common part is sent into various specific parts of the multi-task neural network. Various tasks are processed respectively in various specific parts to determine specific features of each signal respectively. Here, the multiplex signals sent to various specific parts are all the same signals. Alternatively, the multi-task neural network applied to the multi-user detection may not include the common part, and the step of extracting the effective implicit features of the input signals may also be processed in various specific parts.

According to this embodiment, the processing unit 320 inputs the received multiplex signal into the multi-task neural network. In each task of the multi-task neural network, the received multiplex signal is processed, that is, the input to each task in the multi-task neural network is the same. In various tasks of the multi-task neural network, networks configured with different parameters are used to restore one signal form the multiplex signal respectively. First, a preliminary estimated value of the signal is determined, and then interference cancellation is performed to delete the interference caused by other signals from the preliminary estimated value, so as to determine the estimated value of the signal after interference cancellation. The specific method is as follows.

The following takes a task which corresponds to the i-th signal Mᵢ of the multiplex signal received by the base station 300, as an example. In the task Tᵢ, the multiplex signal input to the multi-task neural network are restored to obtain a preliminary estimated value Mᵢ′ of the i-th signal, and then an interference cancellation process is performed on the preliminary estimated value Mᵢ′. In the interference cancellation process, interference is cancelled based on preliminary estimated values of other signals determined by other tasks. Specifically, in the task Tᵢ, the preliminary estimated values regarding the other signals from the other tasks are also received. In the task Tᵢ, the preliminary estimated values of the other signals are subtracted from the preliminary estimated value Mᵢ′ to obtain an estimated value after interference cancellation Mᵢ″. Therefore, the estimated value after interference cancellation Mᵢ″ is an estimated value after cancelling the interference caused by superimposition of the multiple signals, and it has a higher accuracy than the preliminary estimated value Mᵢ′. Similarly, in order to restore signals from other terminals in the other tasks, in the task Tᵢ, the preliminary estimated value Mᵢ′ is also sent to the other tasks, so that the other tasks can perform the interference cancellation process.

According to an example of the present invention, in the processing unit 320, for a task Tᵢ in the multi-task neural network, in the interference cancellation process of the task, the preliminary estimated values of the other tasks can be linearly subtracted from the preliminary estimated value Mᵢ′. For example, a sum of the preliminary estimated values of the other tasks multiplied by a coefficient k may be subtracted from the preliminary estimated value Mᵢ′. For example, it can be represented by the following formula:

$${M}_{i}^{″} = {M}_{i}^{′} - {\sum }_{j = 1 , j \neq i}^{N} {k}_{j} {M}_{j}^{′} \qquad Formula ( 3 )$$

wherein N is the number of the multiple signals, that is, the number of tasks processed by the multi-task neural network, Mⱼ′ is the preliminary estimated value of the other task, and kⱼ is the coefficient corresponding to the preliminary estimated value Mⱼ′. Optionally, for each coefficient kⱼ, it can be specified in advance, or it can be obtained by training a neural network.

According to another example of the present invention, a neural network dedicated to the cancellation step can also be used to perform the above-mentioned subtraction process. In the task Tᵢ, the preliminary estimated value Mᵢ′ of the i-th signal and the preliminary estimated values of the other signals obtained in the other tasks are input to the neural network, and the preliminary estimated values of the other signals are non-linearly subtracted by the neural network from the preliminary estimated value Mᵢ′ to output the estimated value after interference cancellation Mᵢ″, so as to cancel the interference caused by superposition of the multiple signals.

According to an example of the present invention, the multi-task neural network used by the processing unit 320 for the multi-user detection is a multi-layer neural network. The multi-layered multi-task neural network can be divided into multiple interference cancellation stages, and the number of the interference cancellation stages and the number of layers of the neural network included in each interference cancellation stage are arbitrary. For example, each interference cancellation stage may include one or more layers of the neural network, and the above interference cancellation process is performed each time when an interference cancellation stage is went through, and the estimated value after interference cancellation obtained through the interference cancellation process is input into the next interference cancellation stage. In the next interference cancellation stage, in multiple tasks, the preliminary estimated value of each signal of the multiple signals in this interference cancellation stage is determined based on the estimated value after interference cancellation obtained in the previous interference cancellation stage, and in each task, the interference determined based on the preliminary estimated values of the other tasks in this interference cancellation stage is deleted from the preliminary estimated value of the present task in this interference cancellation stage. Therefore, after multiple interference cancellation stages, interference cancellation can be performed more thoroughly.

According to an example of the present invention, in the base station 300, since the processing unit 320 uses a multi-task neural network to perform the multi-user detection, in addition to restoring the received multiplex signal to obtain effective data or control signals from each terminal, user activity detection, PAPR (Peak-to-average ratio) reduction, etc. can also be performed in one or more of the tasks thereof.

According to an example of the present invention, in the processing unit 320, when training and optimizing the neural network for the multi-user detection, the following process is also performed to reduce the loss of the neural network process. The loss represents the difference between the value of a signal restored by the neural network and the true value of the signal, and for example, it can be the mean square error, cross entropy, and so on. In the optimization training of the multi-task neural network, supposing that its objective function includes the losses of various tasks and the balance loss between various tasks, wherein the balance loss between various tasks represents the degree of difference between the losses of various tasks. The neural network is trained to be configured to not only minimize the losses of various tasks, but also minimize the difference between the losses of various tasks. When the multi-task neural network trained in this way is used to restore the multiplex signal, the overall loss of the neural network process can be reduced, and the restoration result of the received multiplex signal can be optimized.

According to the present disclosure, by introducing a multi-task neural network into the multi-user detection of the processing unit 320, the complexity of a receiving end in multi-user communication is reduced. Since only minor adjustments to the network structure and/or parameters of the neural network of the multi-user detection need to be performed according to the adopted transmission scheme so that the base station can be used for reception under this transmission scheme, for a variety of different transmission schemes, the hardware at the receiving end is universal, and its flexibility is improved. In addition, due to the introduction of interference cancellation in the multi-task neural network, and the introduction of balance loss between various tasks in the objective function of the neural network, the bit error rate in the receiving process can be reduced.

The terminal and base station according to an embodiment of the present invention are described above with reference to FIG. 2 and FIG. 3. According to an example of the present invention, in a case that the terminal 200 shown in FIG. 2 is used at the transmitting end and the base station 300 shown in FIG. 3 is used at the receiving end, an end-to-end optimization method can be used to jointly optimize the neural networks adopted by the terminal 200 and the base station 300.

Specifically, in this case, the base station 300 further includes a transmitting unit 330. First, the base station 300 determines network configuration and network parameters of a multi-task neural network used for the multi-user detection on the base station side, and the transmitting unit 330 transmits network configuration information, the network configuration information indicates the network configuration on the base station side, which may be dynamically configured, or statically or quasi-statically configured. After receiving the above-mentioned network configuration information, the receiving unit 220 of the terminal 200 configures a multi-task neural network used for the multi-user detection based on the information, so that joint optimization training can be performed on the neural network of the terminal 200 and the neural network of the base station 300 from end to end. In an example, the network configuration information transmitted by the transmitting unit 330 may be pre-defined pre-coding information, transmission scheme information, etc., for example, it may be the adopted NOMA codebook, or MIMO codebook, etc., which may be exchanged between the terminal 200 and the base station 300 through higher layer signaling or physical layer signaling. In an example, the network configuration information transmitted by the base station 300 may include at least one of information indicating the network configuration of the multi-task neural network adopted by the base station side and information directly indicating the network configuration of the neural network on the terminal side.

According to an example of the present invention, the terminal 200 may also transmit the aforementioned network configuration information to the base station 300, and the base station configures the neural network of the base station according to the network configuration information transmitted by the terminal.

According to an example of the present invention, when joint optimization is performed in an end-to-end manner, the objective function of the neural network is also defined as including the loss of each task and the balance loss between each task, and the neural network is trained for the purpose of minimizing the difference between the loss of each task to reduce the bit error rate.

The above takes the uplink transmission as an example for illustration with the terminal as the transmitting end and the base station as the receiving end, but it is not limited to this. For the downlink transmission from the base station to the terminal or the D2D transmission between devices, the following takes the downlink transmission from the base station to the terminal as an example for illustration.

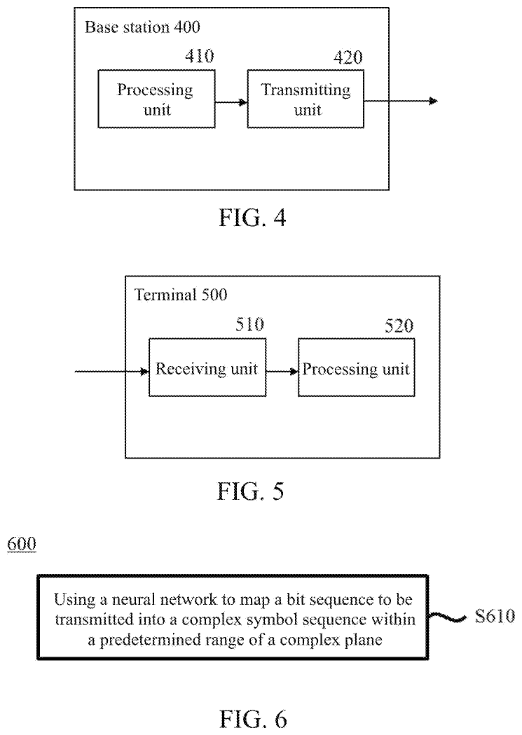

A base station according to another embodiment of the present disclosure is described with reference to FIG. 4. FIG. 4 is a schematic diagram of a base station according to another embodiment of the present disclosure.

As shown in FIG. 4, a base station 400 includes a processing unit 410. In the processing unit 410, based on the non-orthogonal multiple access technology, a multi-user signature (multiple access signature) process and a resource mapping process are performed on a bit sequence composed of bit data to be transmitted to multiple users. According to the present embodiment, in the processing unit 410, a neural network is used to implement the multi-user signature process, that is, a bit sequence to be transmitted is mapped through the neural network, and a complex symbol sequence is output.

According to an example of the present invention, a bit sequence input to the neural network in the processing unit 410 may be a bit sequence that has undergone at least one of encoding, spreading, interleaving, and scrambling, or it may be an unprocessed original bit sequence. In other words, in addition to mapping a bit sequence into a complex symbol sequence, the processes performed in the neural network may include one or more of encoding, spreading, interleaving, scrambling, etc.

For example, the neural network of the base station can map a bit sequence input to the neural network into a complex symbol sequence. And according to an embodiment of the present disclosure, by configuring the structure and parameters of the neural network, the processing unit 410 maps a bit sequence into a complex symbol sequence within a predetermined range of a complex plane. The predetermined range can be expressed as a prescribed shape on the complex plane. Alternatively, the prescribed shape may be any shape, as long as it is a subset of the complex plane. In addition, it can also be combined with knowledge in the field of communication to set the shape to be a shape which is most favorable to transmit communication. Since the mapping range of a bit sequence on the complex plane is limited, comparing with mapping methods such as those using FC-DNN, the number of parameters of a neural network is reduced, and the complexity of optimization training of a neural network is reduced.

According to an example of the present invention, in the processing unit 410, by configuring the parameters of the neural network, a complex symbol sequence obtained by the mapping is defined in a parallelogram on the complex plane. A specific implementation method is as follows.

Assuming that a bit sequence composed of bit data to be transmitted to n terminals needs to be mapped into a complex symbol sequence, the parameter set of the neural network that performs the mapping is configured as Wₙ. Since the complex symbol sequence is to be limited to a parallelogram on the complex plane, the parameter set Wₙ needs to include the length of a long edge, the length of a short edge, and the degrees of two angles of the parallelogram. For example, the parameter set Wₙ can be expressed in the form of the above formula (1).

In addition, assuming that a function R is used to represent the mapping rule of the neural network, R can be regarded as the structure of the neural network, and the form of R is agreed so that a complex symbol sequence obtained by the neural network mapping is limited to a parallelogram on the complex plane. For example, assuming that the maximum number of physical Resource Elements that can be mapped in non-orthogonal multiple access is 4, and each signal to be transmitted to the n terminals uses 2 physical Resource Elements. When the parameter set Wₙ represented by the above formula (1) is used, R can be also represented by the above formula (2).

Through R in formula (2), the parameter set Wₙ can be mapped into a codebook of the complex symbol sequence. On this basis, for the bit sequence to be transmitted which is input to the neural network, according to its input form (for example, it can be a form that satisfies one-hot code, etc.), a corresponding codeword can be selected from the codebook generated above, therefore the mapping of the complex symbol sequence corresponding to the bit sequence is determined. For example, when Wₙ and R(Wₙ) of formula (1) and formula (2) are used, a codebook about the n-th signal obtained by the mapping can be expressed as a sequence: [X^{†}_{n,1}, X^{†}_{n,2}, X^{†}_{n,3}, X^{†}_{n,4}]^{T}. When the bit sequence to be transmitted satisfies the form of the one-hot code, and the n-th signal satisfies [0, 0, 1, 0], X^{†}_{n,3} is selected as the codeword from the above sequence to determine the mapping of the complex symbol sequence corresponding to the n-th signal.

Since the network structure R is agreed to correspond to a parallelogram mapping rule, the position of the determined complex symbol sequence on the complex plane must be within the parallelogram that satisfies the parameters of the parameter set Wₙ.

According to the above example, when the shape of the complex symbol sequence on the complex plane is limited to a shape other than parallelogram, the parameter set Wₙ is the parameters used to characterize the shape, and R is the mapping rule corresponding to the shape.

Through the above processing of the processing unit 410, the complex symbol sequence obtained by the mapping is limited to a subset of the entire complex plane, so that the complexity of the system is reduced when a neural network is applied to the multi-user signature process. In addition, since the parameter set of the neural network is set as parameters for characterizing a certain predetermined shape, the number of parameters of the neural network is reduced. For example, in the training of the neural network, it is only necessary to perform optimization training mainly for the parameter set Wₙ, which reduces the complexity of the training.

In the processing unit 410, the complex symbol sequence obtained through the above process is mapped to a physical resource block. According to an example of the present invention, a neural network technology can be used for resource mapping. The complex symbol sequence is input into a neural network for resource mapping, and the physical resource mapping is realized through the processing of the neural network. At this time, due to the use of a neural network, the mapping of resources can be adjusted and learned. In NOMA or MIMO, the base station 400 transmits, in a non-orthogonal multiple access mode, the bit sequence that has been mapped by the processing unit 410 and has undergone resource mapping. In the resource mapping, data of multiple terminals is allocated to one physical resource block, and the signals to be transmitted to the terminal is multiplex signal including data to be transmitted to multiple users.

Hereinafter, a terminal according to another embodiment of the present disclosure will be explained with reference to FIG. 5. FIG. 5 is a schematic diagram of a terminal according to another embodiment of the present disclosure.

As shown in FIG. 5, a terminal 500 includes a receiving unit 510 and a processing unit 520. The receiving unit 510 receives multiplex signal from the base station, and the multiplex signal includes valid signals for multiple users. The processing unit 520 processes the received multiplex signal to restore one or more signals effective to the terminal 500. That is, the processing unit 520 performs the multi-user detection process on the received multiplex signal.

According to this embodiment, a multi-task neural network is used to perform the multi-user detection process. In the processing unit 520, multiple tasks in the multi-task neural network are used to restore signal from the multiplex signal received by the receiving unit 510.

According to an example of the present invention, the multi-task neural network applied to the multi-user detection process includes a common part and multiple specific parts. Each task in the multi-task neural network shares the common part, and each task in the multi-task neural network corresponds to a specific part. In the processing unit 520, the received multiplex signal is first input into the common part of the multi-task neural network for preprocessing, to determine common features of each signal (that is, features in common), and to extract effective implicit features of the input signals. The multiplex signal processed by the common part is sent into various specific parts of the multi-task neural network. Various tasks are processed respectively in various specific parts to determine specific features of each signal respectively. Here, the multiplex signals sent to various specific parts are all the same signals. Alternatively, the multi-task neural network applied to the multi-user detection may not include the common part, and the step of extracting the effective implicit features of the input signals may also be processed in various specific parts.

According to this embodiment, the processing unit 520 inputs the received multiplex signal into the multi-task neural network. In each task of the multi-task neural network, the received multiplex signal is processed, that is, the input to each task in the multi-task neural network is the same. In various tasks of the multi-task neural network, networks configured with different parameters are used to restore one of the multiple signals respectively. First, a preliminary estimated value of the signal is determined, and then interference cancellation is performed to delete the interference caused by other signals from the preliminary estimated value, so as to determine the estimated value of the signal after interference cancellation. The specific method is as follows.

Assuming that the i-th signal of the multiple signals is effective signal for the terminal 500, the following takes a task Tᵢ, which corresponds to the i-th signal Mᵢ, as an example. In the task Tᵢ, the multiplex signal input to the multi-task neural network is restored to obtain a preliminary estimated value Mᵢ′ of the i-th signal, and then an interference cancellation process is performed on the preliminary estimated value Mᵢ′. In the interference cancellation process, interference is cancelled based on preliminary estimated values of other signals determined by other tasks. Specifically, in the task Tᵢ, the preliminary estimated values regarding the other signals from the other tasks are also received. In the task Tᵢ, the preliminary estimated values of the other signals are subtracted from the preliminary estimated value Mᵢ′ to obtain an estimated value after interference cancellation Mᵢ″. Therefore, the estimated value after interference cancellation Mᵢ″ is an estimated value after cancelling the interference caused by superimposition of the multiple signals, and it has a higher accuracy than the preliminary estimated value Mᵢ′. Similarly, if the interference cancellation is needed in the other tasks, in the task Tᵢ, the preliminary estimated value Mᵢ′ is also sent to the other tasks, so that the other tasks can perform the interference cancellation process.

According to an example of the present invention, in the processing unit 520, for a task Tᵢ in the multi-task neural network, in the interference cancellation process of the task, Tᵢ the preliminary estimated values of the other tasks can be linearly subtracted from the preliminary estimated value Mᵢ′. For example, a sum of the preliminary estimated values of the other tasks multiplied by a coefficient k may be subtracted from the preliminary estimated value Mᵢ′. Optionally, for each coefficient k, it can be specified in advance, or it can be obtained by training a neural network.

According to another example of the present invention, a neural network dedicated to the cancellation step can also be used to perform the above-mentioned subtraction process. In the task Tᵢ, the preliminary estimated value Mᵢ′ of the i-th signal and the preliminary estimated values of the other signals obtained in the other tasks are input to the neural network, and the preliminary estimated values of the other signals are non-linearly subtracted by the neural network from the preliminary estimated value Mᵢ′ to output the estimated value after interference cancellation Mᵢ″, so as to cancel the interference caused by superposition of the multiple signals.

According to an example of the present invention, the multi-task neural network used by the processing unit 520 for the multi-user detection is a multi-layer neural network. The multi-layered multi-task neural network can be divided into multiple interference cancellation stages, and the number of the interference cancellation stages and the number of layers of the neural network included in each interference cancellation stage are arbitrary. For example, each interference cancellation stage may include one or more layers of the neural network, and the above interference cancellation process is performed each time when an interference cancellation stage is went through, and the estimated value after interference cancellation obtained through the interference cancellation process is input into the next interference cancellation stage. In the next interference cancellation stage, in multiple tasks, the preliminary estimated value of each signal of the multiple signals in this interference cancellation stage is determined based on the estimated value after interference cancellation obtained in the previous interference cancellation stage, and in each task, the interference determined based on the preliminary estimated values of the other tasks in this interference cancellation stage is deleted from the preliminary estimated value of the present task in this interference cancellation stage. Therefore, after multiple interference cancellation stages, interference cancellation can be performed more thoroughly.

According to an example of the present invention, in the terminal 500, since the processing unit 520 uses a multi-task neural network to perform the multi-user detection, in addition to restoring the received multiplex signal to obtain effective data or control signals from each terminal, user activity detection, PAPR (Peak-to-average ratio) reduction, etc. can also be performed in one or more of the tasks thereof.

According to an example of the present invention, in the processing unit 520, when training and optimizing the neural network for the multi-user detection, the following process is also performed to reduce the loss of the neural network process. The loss represents the difference between the value of the signal restored by the neural network and the true value of the signal, and for example, it can be the mean square error, cross entropy, and so on. In the optimization training of the multi-task neural network, supposing that its objective function includes the losses of various tasks and the balance loss between various tasks, wherein the balance loss between various tasks represents the degree of difference between the losses of various tasks. The neural network is trained to be configured to not only minimize the losses of various tasks, but also minimize the difference between the losses of various tasks. When the multi-task neural network trained in this way is used to restore the multiplex signal, the overall loss of the neural network process can be reduced, and the restoration result of the received multiplex signal can be optimized.

According to an example of the present invention, the structure and parameters of the multi-task neural network adopted by the processing unit 520 (for example, when the neural network is multi-layered, the weight matrix and bias vector between each layer) can be specified by the base station according to its transmission scheme. In this case, the receiving unit 320 of the terminal 500 receives network configuration information transmitted by the base station. The network configuration information is used to specify the network configuration of a multi-task neural network. For example, the network configuration information includes the network structure and network parameter information of the multi-task neural network. The terminal 500 configures the multi-task neural network based on the received network configuration information. When used online, the terminal 500 can also perform online training and optimization of the multi-task neural network based on the received network configuration information. In an example, the network configuration information may also be pre-defined precoding information, transmission scheme information, etc., for example, it may be a NOMA codebook or a MIMO codebook and so on used by the base station. The network configuration information may be exchanged between the base station and the terminal 500 through high-level signaling or physical layer signaling.

According to another example of the present invention, the terminal 500 may also determine the communication scheme of the base station through a blind detection method, thereby determining the network parameters and network structure of the multi-task neural network used for the multi-user detection. In this case, the process of signaling interaction with the base station can be omitted.

According to the present disclosure, by introducing a multi-task neural network into the multi-user detection of the processing unit 520, the complexity of a receiving end in multi-user communication is reduced. Since only minor adjustments to the network structure and/or parameters of the neural network of the multi-user detection need to be performed according to the transmission scheme on the base station side so that the terminal can be used for reception under this transmission scheme, for a variety of different transmission schemes, the hardware at the receiving end is universal, and its flexibility is improved. In addition, due to the introduction of interference cancellation in the multi-task neural network, and the introduction of balance loss between various tasks in the objective function of the neural network, the bit error rate in the receiving process can be reduced.

The terminal and base station according to an embodiment of the present invention are described above with reference to FIG. 4 and FIG. 5. According to an example of the present invention, in a case that the base station 400 shown in FIG. 4 is used at the transmitting end and the terminal 500 shown in FIG. 5 is used at the receiving end, an end-to-end optimization method can be used to jointly optimize the neural networks adopted by the base station 400 and the terminal 500.

Specifically, in this case, the base station 400 further includes a transmitting unit 420. First, the base station 400 determines network configuration of a neural network used for the multi-user signature on the base station side such as the network structure and network parameters (for example, the above-mentioned R and We), and the transmitting unit 420 transmits network configuration information, wherein the network configuration information indicates the network configuration on the base station side, which may be dynamically configured, or statically or quasi-statically configured. After receiving the foregoing network configuration information, the receiving unit 510 of the terminal 500 configures a multi-task neural network used for the multi-user detection based on the information (for example, setting several interference cancellation stages, adopting a linear or non-linear interference cancellation method, etc.), thereby joint optimization training can be performed on the neural network of the base station 400 and the neural network of the terminal 500 from end to end. In an example, the network configuration information transmitted by the transmitting unit 420 may be pre-defined precoding information, transmission scheme information, etc., for example, it may be a NOMA codebook or a MIMO codebook used by the base station. The above-mentioned information may be exchanged between the base station 400 and the terminal 500 through high-level signaling or physical layer signaling. In an example, the network configuration information transmitted by the base station 400 may include at least one of information indicating the network configuration of the neural network adopted by the base station 400 and information directly indicating the network configuration of the multi-task neural network on the terminal side.

According to an example of the present invention, when joint optimization is performed in an end-to-end manner, the objective function of the neural network is also defined as including the loss of each task and the balance loss between each task, and the neural network is trained for the purpose of minimizing the difference between the loss of each task to reduce the bit error rate.

Regardless of whether it is in uplink transmission or downlink transmission, any training method, such as a gradient descent training method, can be used for the optimization training of the neural network involved in the above description.

Next, a transmission method performed by a terminal or a base station will be explained with reference to FIG. 6. FIG. 6 is a flowchart of a method performed by a terminal or a base station as a transmitting end according to an embodiment of the present disclosure.

As shown in FIG. 6, a method 600 includes step S610. According to this embodiment, in step S610, a neural network is used to perform a multi-user signature (multiple access signature) process on a bit sequence composed of bit data to be transmitted to multiple users, that is, a bit sequence to be transmitted is mapped through a neural network, and a complex symbol sequence is output.

According to an example of the present invention, the bit sequence input to the neural network in step S610 may be a bit sequence that has undergone at least one of encoding, spreading, interleaving, and scrambling, or it may be an unprocessed original bit sequence. In other words, in addition to mapping a bit sequence into a complex symbol sequence, the processes performed in the neural network may include one or more of encoding, spreading, interleaving, scrambling, etc.

For example, a multi-user signature mapping model can be used to map a bit sequence input to the neural network into a complex symbol sequence. And according to an embodiment of the present disclosure, in step S610, by configuring the structure and parameters of the neural network, the bit sequence is mapped into a complex symbol sequence within a predetermined range of a complex plane. The predetermined range can be expressed as a prescribed shape on the complex plane. Alternatively, the prescribed shape may be any shape, as long as it is a subset of the complex plane. In addition, it can also be combined with knowledge in the field of communication to set the shape to be a shape which is most favorable to transmit communication. Since the mapping range of a bit sequence on the complex plane is limited, comparing with mapping methods such as those using FC-DNN, the number of parameters of a neural network is reduced, and the complexity of optimization training of a neural network is reduced.

According to an example of the present invention, in step S610, by configuring the parameters of the neural network, a complex symbol sequence obtained by the mapping is defined in a parallelogram on the complex plane. A specific implementation method is as follows.

Specifically, assuming that a bit sequence composed of bit data of n signals to be transmitted is mapped into a complex symbol sequence, the parameter set of the neural network that performs the mapping is configured as Wₙ. Since the complex symbol sequence is to be limited to a parallelogram on the complex plane, the parameter set Wₙ needs to include parameters such as the length of a long edge, the length of a short edge, and the degrees of two angles of the parallelogram, etc.

In addition, assuming that a function R is used to represent the mapping rule of the neural network, R can be regarded as the structure of the neural network, and the form of R is agreed so that a complex symbol sequence obtained by the neural network mapping is limited to a parallelogram on the complex plane. The specific mapping methods have been described above, and will not be repeated here.

Through the above process in step S610, the complex symbol sequence obtained by the mapping is limited to a subset of the entire complex plane, so that the complexity of the system is reduced when a neural network is applied to the multi-user signature process. In addition, since the parameter set of the neural network is set as parameters for characterizing a certain predetermined shape, the number of parameters of the neural network is reduced. For example, in the training of the neural network, it is only necessary to perform the optimization training mainly for the parameter set Wₙ, which reduces the complexity of the training.

The method 600 may further include step S620. In step S620, the complex symbol sequence obtained through the above process is mapped to a physical resource block. According to an example of the present invention, a neural network technology can be used for resource mapping. The complex symbol sequence is input into a neural network for resource mapping, and the physical resource mapping is realized through the processing of the neural network. At this time, due to the use of a neural network, the mapping of resources can be adjusted and learned. A terminal or a base station adopting the method 600 transmits, in a non-orthogonal multiple access mode, the bit sequence that has been mapped in step S610 and has undergone resource mapping in step S620. In the resource mapping, data of multiple users is allocated to one physical resource block.

FIG. 7 is a flowchart of a method performed by a base station or a terminal as a receiving end according to an embodiment of the present disclosure.

As shown in FIG. 7, a method 700 includes step S710, step S720, and step S730. Step S710 receives multiplex signal from a transmitting end, and multiple effective signals are superimposed on the multiplex signal. In step S720 and step S730, the received multiplex signal is processed to restore effective information of each signal. That is, steps S720 and S730 perform a multi-user detection process on the received multiplex signal.

According to this embodiment, a multi-task neural network is used to perform the multi-user detection process. In step S720 and step S730, the multiplex signal received in step S710 is restored through multiple tasks in the multi-task neural network.

According to an example of the present invention, the multi-task neural network applied to the multi-user detection process includes a common part and multiple specific parts. Each task in the multi-task neural network shares the common part, and each task in the multi-task neural network corresponds to a specific part. The common part of the multi-task neural network is used for preprocessing to determine common features of each signal (that is, features in common), and to extract effective implicit features of the input signals. Various tasks are processed respectively in various specific parts to determine specific features of each signal respectively. Here, the input signals of various specific parts are all the same signals. Alternatively, the multi-task neural network applied to the multi-user detection may not include the common part, and the step of extracting the effective implicit features of the input signals may also be processed in various specific parts.

According to this embodiment, in step S720, the received multiplex signal are input into the multi-task neural network. In each task of the multi-task neural network, the received multiplex signal are processed, that is, the input to each task in the multi-task neural network is the same. In various tasks of the multi-task neural network, networks configured with different parameters are used to restore one of the multiple signals respectively. In step S720, first a preliminary estimated value of the signal is determined, and then interference cancellation is performed in step S730 to delete the interference caused by other signals from the preliminary estimated value, so as to determine the estimated value of the signal after interference cancellation. The specific method is as follows.

The following takes a task which corresponds to the i-th signal Mᵢ of the multiplex signal, as an example. In step S720, in the task Tᵢ, the multiplex signal input to the multi-task neural network are restored to obtain a preliminary estimated value Mᵢ′ of the i-th signal, and next, in step S730, an interference cancellation process is performed on the preliminary estimated value Mᵢ′. wherein the interference is cancelled based on preliminary estimated values of other signals determined by other tasks. Specifically, in step S730, in the task Tᵢ, the preliminary estimated values regarding the other signals from the other tasks are also received. In the task Tᵢ, the preliminary estimated values of the other signals are subtracted from the preliminary estimated value Mᵢ′ to obtain an estimated value after interference cancellation Mᵢ″. Therefore, the estimated value after interference cancellation Mᵢ″ is an estimated value after cancelling the interference caused by superimposition of the multiplex signal, and it has a higher accuracy than the preliminary estimated value Mᵢ′. Similarly, in order to restore the effective signals of the other tasks, in the task Tᵢ, the preliminary estimated value Mᵢ′ is also sent to the other tasks, so that the other tasks can perform the interference cancellation process.

According to an example of the present invention, in step S730, for a task Tᵢ in the multi-task neural network, in the interference cancellation process of the task, the preliminary estimated values of the other tasks can be linearly subtracted from the preliminary estimated value Mᵢ′. For example, a sum of the preliminary estimated values of the other tasks multiplied by a coefficient k may be subtracted from the preliminary estimated value Mᵢ′. For the coefficient k of each task, it can be specified in advance, or it can be obtained by training a neural network.

According to another example of the present invention, a neural network dedicated to the cancellation step can also be used to perform the above-mentioned subtraction process. In step S730, in the task Tᵢ, the preliminary estimated value Mᵢ′ of the i-th signal and the preliminary estimated values of the other signals obtained in the other tasks are input to the neural network, and the preliminary estimated values of the other signals are non-linearly subtracted by the neural network from the preliminary estimated value Mᵢ′ to output the estimated value after interference cancellation Mᵢ″, so as to cancel the interference caused by superposition of the multiple signals.

According to an example of the present invention, the multi-task neural network used for the multi-user detection is a multi-layer neural network. The multi-layered multi-task neural network can be divided into multiple interference cancellation stages, and the number of the interference cancellation stages and the number of layers of the neural network included in each interference cancellation stage are arbitrary. For example, each interference cancellation stage may include one or more layers of the neural network, and the above interference cancellation process is performed each time when an interference cancellation stage is went through, and the estimated value after interference cancellation obtained through the interference cancellation process is input into the next interference cancellation stage. In the next interference cancellation stage, in multiple tasks, by applying step S720, the preliminary estimated value of each signal of the multiple signals in this interference cancellation stage is determined based on the estimated value after interference cancellation obtained in the previous interference cancellation stage, and in each task, by applying step S730, the interference determined based on the preliminary estimated values of the other tasks in this interference cancellation stage is deleted from the preliminary estimated value of the present task in this interference cancellation stage. Therefore, after multiple interference cancellation stages, interference cancellation can be performed more thoroughly.

According to an example of the present invention, in the method 700, a multi-task neural network is used to perform the multi-user detection. Thus, in addition to restoring the received multiplex signal to obtain effective data or control signals transmitted to the present terminal, user activity detection, PAPR (Peak-to-average ratio) reduction, etc. can also be performed in one or more of the tasks thereof.

According to an example of the present invention, when training and optimizing the neural network for the multi-user detection, the following process is also performed to reduce the loss of the neural network process. The loss represents the difference between the value of the signal restored by the neural network and the true value of the signal, and for example, it can be the mean square error, cross entropy, and so on. In the optimization training of the multi-task neural network, supposing that its objective function includes the losses of various tasks and the balance loss between various tasks, wherein the balance loss between various tasks represents the degree of difference between the losses of various tasks. The neural network is trained to be configured to not only minimize the losses of various tasks, but also minimize the difference between the losses of various tasks. When the multi-task neural network trained in this way is used to restore the multiplex signal, the overall loss of the neural network process can be reduced, and the restoration result of the received multiplex signal can be optimized.

According to an example of the present invention, for the above method 600 and method 700, regardless of whether the terminal side adopts the transmitting method or the receiving method, the structure and parameters of the neural network applied to the terminal can be specified by the base station according to the transmitting scheme. In this case, the terminal applying the method 600 and the method 700 also receives network configuration information transmitted by the base station. The network configuration information is used to specify the network configuration of the neural network of the terminal. For example, the network configuration information includes network structure and network parameter information. Based on the received network configuration information, the terminal configures its neural network. When used online, the terminal can also perform online training and optimization of its neural network based on the received network configuration information. In an example, the network configuration information may also be pre-defined pre-coding information, transmission scheme information, etc., for example, it may be the adopted NOMA codebook or MIMO codebook and so on. The network configuration information may be exchanged between the base station and the terminal through high-level signaling or physical layer signaling.

According to another example of the present invention, the terminal may also transmit the aforementioned network configuration information to the base station to specify the neural network configuration of the base station or to help the base station determine the neural network configuration to be used.

According to another example of the present invention, the terminal applying the method 600 and the method 700 can also determine the communication scheme of the base station through a blind detection method, thereby determining the network parameters and network structure of the multi-task neural network used for the multi-user detection. In this case, the process of signaling interaction with the base station can be omitted.

According to an example of the present invention, when the transmitting end and the receiving end adopt the above-mentioned method 600 and method 700 respectively, an end-to-end optimization method can be used to jointly optimize the neural networks adopted by the transmitting end and the receiving end.

Specifically, in this case, the base station using the above method 600 and method 700 determines network configuration and network parameters of the neural network it uses, and transmits network configuration information to the terminal using the above method 600 and method 700. The network configuration information indicates the network configuration on the base station side, which may be dynamically configured, or statically or quasi-statically configured. After receiving the foregoing network configuration information, the terminal configures a multi-task neural network of the terminal based on the information, thereby joint optimization training can be performed on the neural networks adopted by the transmitting end and the receiving end from end to end. In an example, the network configuration information transmitted by the base station may be pre-defined pre-coding information, transmission scheme information, etc., for example, it may be a NOMA codebook or a MIMO codebook used by the base station. The above-mentioned information may be exchanged between the transmitting end and the receiving end through high-level signaling or physical layer signaling. In an example, the transmitted network configuration information may include at least one of information indicating the network configuration of the neural network adopted by the base station and information directly indicating the network configuration of the multi-task neural network on the terminal side.

According to an example of the present invention, when joint optimization is performed in an end-to-end manner, the objective function of the neural network can also be defined as including the losses of various tasks and the balance loss between various tasks, and the neural network is trained for the purpose of minimizing the difference between the losses of various tasks to reduce the bit error rate.

In addition, any training method, such as a gradient descent training method, can be used for the optimization training of the neural network involved in the above description.

<Hardware Structure>

In addition, block diagrams used in the description of the above embodiments illustrate blocks in units of functions. These functional blocks (structural blocks) may be implemented in arbitrary combination of hardware and/or software. Furthermore, means for implementing respective functional blocks is not particularly limited. That is, the respective functional blocks may be implemented by one apparatus that is physically and/or logically jointed; or more than two apparatuses that are physically and/or logically separated may be directly and/or indirectly connected (e.g. wired and/or wirelessly), and the respective functional blocks may be implemented by these apparatuses.

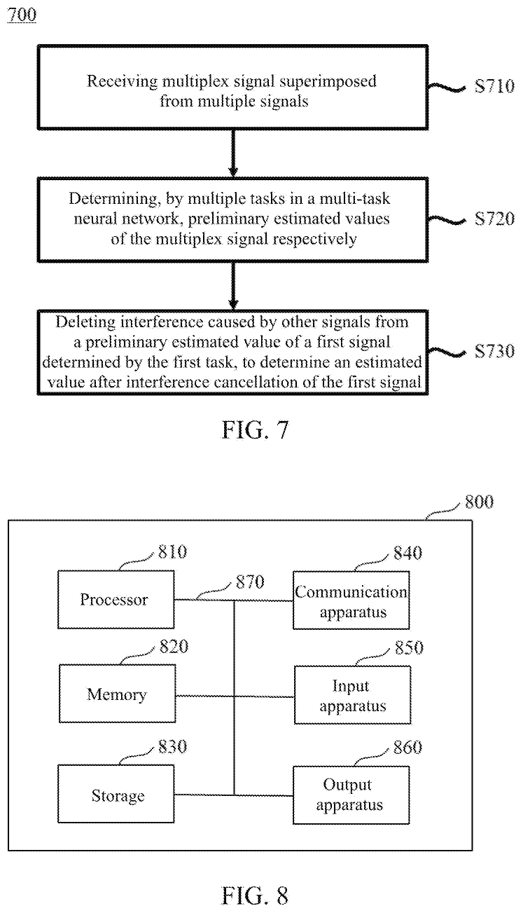

For example, a device (such as, the first communication device, the second communication device, the aerial user terminal, etc.) in an embodiment of the present disclosure may function as a computer that executes the processes of the wireless communication method of the present disclosure. FIG. 8 is a schematic diagram of a hardware structure of a device 800 involved in an embodiment of the present disclosure. The above device 800 may be constituted as a computer apparatus that physically comprises a processor 810, a memory 820, a storage 830, a communication apparatus 840, an input apparatus 850, an output apparatus 860, a bus 870 and the like

In addition, in the following description, terms such as “apparatus” may be replaced with circuits, devices, units, and the like. The hardware structure of the user terminal and the base station may include one or more of the respective apparatuses shown in the figure, or may not include a part of the apparatuses.

For example, only one processor 810 is illustrated, but there may be multiple processors. Furthermore, processes may be performed by one processor, or processes may be performed by more than one processor simultaneously, sequentially, or with other methods. In addition, the processor 810 may be installed by more than one chip.

Respective functions of any of the device 800 may be implemented, for example, by reading specified software (program) on hardware such as the processor 810 and the memory 820, so that the processor 810 performs computations, controls communication performed by the communication apparatus 840, and controls reading and/or writing of data in the memory 820 and the storage 830.

The processor 810, for example, operates an operating system to control the entire computer. The processor 810 may be constituted by a Central Processing Unit (CPU), which includes interfaces with peripheral apparatuses, a control apparatus, a computing apparatus, a register and the like. For example, the determining unit, the adjusting unit and the like described above may be implemented by the processor 810.

In addition, the processor 810 reads programs (program codes), software modules and data from the storage 830 and/or the communication apparatus 840 to the memory 820, and execute various processes according to them. As for the program, a program causing computers to execute at least a part of the operations described in the above embodiments may be employed. For example, the determining unit of the user terminal 500 may be implemented by a control program stored in the memory 820 and operated by the processor 810, and other functional blocks may also be implemented similarly.

The memory 820 is a computer-readable recording medium, and may be constituted, for example, by at least one of a Read Only Memory (ROM), an Erasable Programmable ROM (EPROM), an Electrically EPROM (EEPROM), a Random Access Memory (RAM) and other appropriate storage media. The memory 820 may also be referred to as a register, a cache, a main memory (a main storage apparatus) and the like. The memory 820 may store executable programs (program codes), software modules and the like for implementing a method involved in an embodiment of the present disclosure.

The storage 830 is a computer-readable recording medium, and may be constituted, for example, by at least one of a flexible disk, a Floppy® disk, a magneto-optical disk (e.g., a Compact Disc ROM (CD-ROM) and the like), a digital versatile disk, a Blu-ray® disk, a removable disk, a hard driver, a smart card, a flash memory device (e.g., a card, a stick and a key driver), a magnetic stripe, a database, a server, and other appropriate storage media. The storage 830 may also be referred to as an auxiliary storage apparatus.

The communication apparatus 840 is a hardware (transceiver device) performing communication between computers via a wired and/or wireless network, and is also referred to as a network device, a network controller, a network card, a communication module and the like, for example. The communication apparatus 840 may include a high-frequency switch, a duplexer, a filter, a frequency synthesizer and the like to implement, for example, Frequency Division Duplex (FDD) and/or Time Division Duplex (TDD). For example, the transmitting unit, the receiving unit and the like described above may be implemented by the communication apparatus 840.

The input apparatus 850 is an input device (e.g., a keyboard, a mouse, a microphone, a switch, a button, a sensor and the like) that receives input from the outside. The output apparatus 860 is an output device (e.g., a display, a speaker, a Light Emitting Diode (LED) light and the like) that performs outputting to the outside. In addition, the input apparatus 850 and the output apparatus 860 may also be an integrated structure (e.g., a touch screen).

Furthermore, the respective apparatuses such as the processor 810 and the memory 820 are connected by the bus 870 that communicates information. The bus 870 may be constituted by a single bus or by different buses between the apparatuses.

Furthermore, the base station and the user terminal may comprise hardware such as a microprocessor, a Digital Signal Processor (DSP), an Application Specified Integrated Circuit (ASIC), a Programmable Logic Device (PLD), a Field Programmable Gate Array (FPGA), etc., and the hardware may be used to implement a part of or all of the respective functional blocks. For example, the processor 810 may be installed by at least one of these hardware.

(Variations)

In addition, the embodiments described above may be used in combination. In addition, the terms illustrated in the present specification and/or the terms required for understanding of the present specification may be substituted with terms having the same or similar meaning. For example, a channel and/or a symbol may also be a signal (signaling). Furthermore, the signal may be a message. A reference signal may be abbreviated as an “RS”, and may also be referred to as a pilot, a pilot signal and so on, depending on the standard applied. Furthermore, a component carrier (CC) may also be referred to as a cell, a frequency carrier, a carrier frequency, and the like.

Furthermore, the information, parameters and so on described in this specification may be represented in absolute values or in relative values with respect to specified values, or may be represented by other corresponding information. For example, radio resources may be indicated by specified indexes. Furthermore, formulas and the like using these parameters may be different from those explicitly disclosed in this specification.

The names used for the parameters and the like in this specification are not limited in any respect. For example, since various channels (Physical Uplink Control Channels (PUCCHs), Physical Downlink Control Channels (PDCCHs), etc.) and information elements may be identified by any suitable names, the various names assigned to these various channels and information elements are not limitative in any respect.

The information, signals and the like described in this specification may be represented by using any one of various different technologies. For example, data, instructions, commands, information, signals, bits, symbols, chips, etc. possibly referenced throughout the above description may be represented by voltages, currents, electromagnetic waves, magnetic fields or particles, optical fields or photons, or any combination thereof.

In addition, information, signals and the like may be output from higher layers to lower layers and/or from lower layers to higher layers. Information, signals and the like may be input or output via a plurality of network nodes.

The information, signals and the like that are input or output may be stored in a specific location (for example, in a memory), or may be managed in a control table. The information, signals and the like that are input or output may be overwritten, updated or appended. The information, signals and the like that are output may be deleted. The information, signals and the like that are input may be transmitted to other apparatuses.

Reporting of information is by no means limited to the manners/embodiments described in this specification, and may be implemented by other methods as well. For example, reporting of information may be implemented by using physical layer signaling (for example, downlink control information (DCI), uplink control information (UCI)), higher layer signaling (for example, RRC (Radio Resource Control) signaling, broadcast information (master information blocks (MIBs), system information blocks (SIBs), etc.), MAC (Medium Access Control) signaling), other signals or combinations thereof.

In addition, physical layer signaling may also be referred to as L1/L2 (Layer 1/Layer 2) control information (L1/L2 control signals), L1 control information (L1 control signal) and the like. Furthermore, RRC signaling may also be referred to as RRC messages, for example, RRC connection setup messages, RRC connection reconfiguration messages, and so on. Furthermore, MAC signaling may be reported by using, for example, MAC control elements (MAC CEs).

Furthermore, notification of prescribed information (for example, notification of “being X”) is not limited to being performed explicitly, and may be performed implicitly (for example, by not performing notification of the prescribed information or by notification of other information).

Decision may be performed by a value (0 or 1) represented by 1 bit, or by a true or false value (Boolean value) represented by TRUE or FALSE, or by a numerical comparison (e.g., comparison with a prescribed value).

Software, whether referred to as “software”, “firmware”, “middleware”, “microcode” or “hardware description language”, or called by other names, should be interpreted broadly to mean instructions, instruction sets, code, code segments, program codes, programs, subprograms, software modules, applications, software applications, software packages, routines, subroutines, objects, executable files, execution threads, procedures, functions and so on.

In addition, software, commands, information, etc. may be transmitted and received via a transport medium. For example, when software is transmitted from web pages, servers or other remote sources using wired technologies (coaxial cables, fibers, twisted pairs, Digital Subscriber Lines (DSLs), etc.) and/or wireless technologies (infrared ray, microwave, etc.), these wired technologies and/or wireless technologies are included in the definition of the transport medium.

The terms “system” and “network” used in this specification may be used interchangeably.

In this specification, terms like “Base Station (BS)”, “wireless base station”, “eNB”, “gNB”, “cell”, “sector”, “cell group”, “carrier” and “component carrier” may be used interchangeably. A base station is sometimes referred to as terms such as a fixed station, a NodeB, an eNodeB (eNB), an access point, a transmitting point, a receiving point, a femto cell, a small cell and the like.

A base station is capable of accommodating one or more (for example, three) cells (also referred to as sectors). In the case where the base station accommodates a plurality of cells, the entire coverage area of the base station may be divided into a plurality of smaller areas, and each smaller area may provide communication services by using a base station sub-system (for example, a small base station for indoor use (a Remote Radio Head (RRH)). Terms like “cell” and “sector” refer to a part of or an entirety of the coverage area of a base station and/or a sub-system of the base station that provides communication services in this coverage.

In this specification, terms such as “Mobile Station (MS)”, “user terminal”, “User Equipment (UE)”, and “terminal” may be used interchangeably. The mobile station is sometimes referred by those skilled in the art as a user station, a mobile unit, a user unit, a wireless unit, a remote unit, a mobile device, a wireless device, a wireless communication device, a remote device, a mobile user station, an access terminal, a mobile terminal, a wireless terminal, a remote terminal, a handset, a user agent, a mobile client, a client, or some other appropriate terms.

Furthermore, a wireless base station in this specification may also be replaced with a user terminal. For example, for a structure in which communication between a wireless base station and a user terminal is replaced with communication between a plurality of user terminals (Device-to-Device, D2D), the respective manners/embodiments of the present disclosure may also be applied. At this time, functions provided by the first communication device and the second communication device of the above device 800 may be regarded as functions provided by a user terminal. Furthermore, the words “uplink” and “downlink” may also be replaced with “side”. For example, an uplink channel may be replaced with a side channel.

Also, a user terminal in this specification may be replaced with a wireless base station. At this time, functions provided by the above user terminal may be regarded as functions provided by the first communication device and the second communication device.

In this specification, specific actions configured to be performed by the base station sometimes may be performed by its upper nodes in certain cases. Obviously, in a network composed of one or more network nodes having base stations, various actions performed for communication with terminals may be performed by the base stations, one or more network nodes other than the base stations (for example, Mobility Management Entities (MMEs), Serving-Gateways (S-GWs), etc., may be considered, but not limited thereto)), or combinations thereof.

The respective manners/embodiments described in this specification may be used individually or in combinations, and may also be switched and used during execution. In addition, orders of processes, sequences, flow charts and so on of the respective manners/embodiments described in this specification may be re-ordered as long as there is no inconsistency. For example, although various methods have been described in this specification with various units of steps in exemplary orders, the specific orders as described are by no means limitative.

The manners/embodiments described in this specification may be applied to systems that utilize Long Term Evolution (LTE), Advanced Long Term Evolution (LTE-A, LTE-Advanced), Beyond Long Term Evolution (LTE-B, LTE-Beyond), the super 3rd generation mobile communication system (SUPER 3G), Advanced International Mobile Telecommunications (IMT-Advanced), the 4th generation mobile communication system (4G), the 5th generation mobile communication system (5G), Future Radio Access (FRA), New Radio Access Technology (New-RAT), New Radio (NR), New radio access (NX), Future generation radio access (FX), Global System for Mobile communications (GSM®), Code Division Multiple Access 3000 (CDMA 3000), Ultra Mobile Broadband (UMB), IEEE 920.11 (Wi-Fi®), IEEE 920.16 (WiMAX®), IEEE 920.20, Ultra-Wide Band (UWB), Bluetooth® and other appropriate wireless communication methods, and/or next-generation systems that are enhanced based on them.

Terms such as “based on” as used in this specification do not mean “based on only”, unless otherwise specified in other paragraphs. In other words, terms such as “based on” mean both “based on only” and “at least based on.”

Any reference to units with designations such as “first”, “second” and so on as used in this specification does not generally limit the quantity or order of these units. These designations may be used in this specification as a convenient method for distinguishing between two or more units. Therefore, reference to a first unit and a second unit does not imply that only two units may be employed, or that the first unit must precedes the second unit in several ways.

Terms such as “deciding (determining)” as used in this specification may encompass a wide variety of actions. The “deciding (determining)” may regard, for example, calculating, computing, processing, deriving, investigating, looking up (e.g., looking up in a table, a database or other data structures), ascertaining, etc. as performing the “deciding (determining)”. In addition, the “deciding (determining)” may also regard receiving (e.g., receiving information), transmitting (e.g., transmitting information), inputting, outputting, accessing (e.g., accessing data in a memory), etc. as performing the “deciding (determining)”. In addition, the “deciding (determining)” may further regard resolving, selecting, choosing, establishing, comparing, etc. as performing the “deciding (determining)”. That is to say, the “deciding (determining)” may regard certain actions as performing the “deciding (determining)”.

As used herein, terms such as “connected”, “coupled”, or any variation thereof mean any direct or indirect connection or coupling between two or more units, and may include the presence of one or more intermediate units between two units that are “connected” or “coupled” to each other. Coupling or connection between the units may be physical, logical or a combination thereof. For example, “connection” may be replaced with “access.” As used in this specification, two units may be considered as being “connected” or “coupled” to each other by using one or more electrical wires, cables and/or printed electrical connections, and, as a number of non-limiting and non-inclusive examples, by using electromagnetic energy having wavelengths in the radio frequency region, microwave region and/or optical (both visible and invisible) region.

When terms such as “including”, “comprising” and variations thereof are used in this specification or the claims, these terms, similar to the term “having”, are also intended to be inclusive. Furthermore, the term “or” as used in this specification or the claims is not an exclusive or.

Although the present disclosure has been described above in detail, it should be obvious to a person skilled in the art that the present disclosure is by no means limited to the embodiments described in this specification. The present disclosure may be implemented with various modifications and alterations without departing from the spirit and scope of the present disclosure defined by the recitations of the claims. Consequently, the description in this specification is for the purpose of illustration, and does not have any limitative meaning to the present disclosure.

1. A terminal, comprising:
a processing unit configured to use a neural network to map a bit sequence to be transmitted into a complex symbol sequence, wherein the neural network is configured to map the bit sequence into the complex symbol sequence within a predetermined range of a complex plane.

2. The terminal of claim 1, wherein,
the terminal further comprises a receiving unit, the receiving unit receives network configuration information transmitted by the base station that includes at least one of information for indicating a network configuration of the neural network used by the base station and information for indicating the network configuration of the neural network of the terminal.

3. The terminal of claim 2, wherein,
the processing unit configures the neural network of the terminal based on the network configuration information.

4. The terminal according to claim 2, wherein,
the network configuration information includes network structure and network parameter information.

5. A base station, comprising:
a receiving unit configured to receive multiplex signal superimposed from multiple signals transmitted by multiple terminals; and
a processing unit configured to restore the multiplex signal, determine preliminary estimated values of the multiplex signal through multiple tasks in a multi-task neural network, and in a first task of the multi-task neural network, delete interference caused by other signals of the multiple signals from a preliminary estimated value of a first signal determined by the first task, to determine an estimated value after interference cancellation of the first signal,
wherein the interference caused by the other signals of the multiple signals is obtained based on the preliminary estimated values determined by tasks of the multiple tasks other than the first task.

6. The base station of claim 5, wherein,
the multi-task neural network includes a common part and multiple specific parts, each task in the multi-task neural network shares the common part which is used to determine common features of each signal of the multiple signals, and each task in the multi-task neural network corresponds to one of the specific parts which are used to determine specific features of each signal respectively.

7. The base station of claim 5, wherein,
the multi-task neural network includes multiple layers,
the multi-task neural network includes multiple interference cancellation stages, and each interference cancellation stage includes one or more layers of the neural network,
in a first interference cancellation stage, the preliminary estimated values of the multiplex signal in the first interference cancellation stage are respectively determined through the multiple tasks, and the interference obtained based on the preliminary estimated values of the other signals in the first interference cancellation stage is deleted from the preliminary estimated value of the first signal in the first interference cancellation stage determined by the first task, to determine the estimated value after interference cancellation of the first signal in the first interference cancellation stage,
in a second interference cancellation stage, the preliminary estimated values of the multiplex signal in a second interference cancellation stage are respectively determined through the multiple tasks based on estimated values after interference cancellation of the multiplex signal in the first interference cancellation stage, and the interference obtained based on the preliminary estimated values of the other signals in the second interference cancellation stage is deleted from the preliminary estimated value of the first signal in the second interference cancellation stage.

8. The base station of claim 5, further comprising:
a transmitting unit configured to transmit information related to a structure and parameters of the multi-task neural network.

9. The base station of claim 5, wherein,
the multi-task neural network is configured to balance a loss of each of the multiple tasks,
the loss is a difference between a value of a signal restored by each task and a true value of the signal.

10. (canceled)

11. A transmitting method, comprising:
using a neural network to map a bit sequence to be transmitted into a complex symbol sequence, wherein the neural network is configured to map the bit sequence into the complex symbol sequence within a predetermined range of a complex plane.
